(19) United States
(12) Patent Application Publication
(10) Pub. No.: US 2011/0321092 A1
(43) Pub. Date: Dec. 29, 2011

(54) PORTABLE TERMINAL, CONTENT REPRODUCTION SYSTEM, REMOTE CONTROLLER AND TELEVISION APPARATUS

(75) Inventor: Eiji Uchida, Osaka City (JP)

(73) Assignee: SANYO ELECTRIC CO., LTD., Moriguichi City (JP)

(21) Appl. No.: 13/167,088

(22) Filed: Jun. 23, 2011

(30) Foreign Application Priority Data
Jun. 23, 2010 (JP) 2010-142467

(51) Int. Cl. H04H 60/09; H04N 5/445; H04W 4/06

(52) U.S. Cl. 725/39; 455/3.06; 455/3.04; 725/37

(57) ABSTRACT

A portable terminal includes: a communication portion that communicates with an electronic device to acquire content from the electronic device; and a reproduction portion that reproduces the content acquired through the communication portion.

This nonprovisional application claims priority under 35 U.S.C. §119(a) on Patent Application No. 2010-142467 filed in Japan on Jun. 23, 2010, the entire contents of which are hereby incorporated by reference.

### BACKGROUND OF THE INVENTION

1. Field of the Invention

The present invention relates to a portable terminal, a content reproduction system that includes the portable terminal and an electronic device, a remote controller and a television apparatus.

2. Description of Related Art

In recent years, as wireless communication technology has advanced, electronic devices that perform communication conforming to DLNA (digital living network alliance, a registered trademark) have been widely used. DNLA is an alliance that defines specifications on communication, such as communication standards between electronic devices and the formats of content which is communicated; various types of electronic devices can communicate with each other by performing the communication conforming to DNLA.

The operation of an electronic device such as an audio visual device is controlled by a signal transmitted by a remote controller manipulated by a user. In the electronic device that can perform mutual communication described above, the user can instruct a plurality of electronic devices to operate simply by manipulating only one remote controller.

As a conventional example, there is proposed a content reproduction system including a remote controller that transmits a signal corresponding to an external device (digital camera) connected thereto and a television apparatus whose operation is controlled by the signal. In the content reproduction system, the television apparatus that receives the signal transmitted from the remote controller connected to the external device communicates with an external storage device or the external device, and thereby acquires and reproduces content corresponding to the external device.

However, even in any conventional content reproduction system other than the content reproduction system described as the convention example, unless a user is around an electronic device (for example, a television apparatus) that reproduces content, the user cannot watch the reproduced content. Furthermore, since an electronic device such as a television apparatus is large and heavy, and needs to stably acquire content from the interior (for example, a recorder that can perform mutual communication) of the content reproduction system and from the exterior (for example, a broadcast station), it is difficult to change the location where the electronic device is placed. This disadvantageously limits the location where the user can watch content.

### SUMMARY OF THE INVENTION

A portable terminal according to the present invention includes: a communication portion that communicates with an electronic device to acquire content from the electronic device; and a reproduction portion that reproduces the content acquired through the communication portion. A content reproduction system according to the present invention includes: at least one electronic device; and the portable terminal configured as described above that can communicate with the electronic device, in which content produced by the electronic device is acquired by the portable terminal through the communication portion and is reproduced by the reproduction portion.

### BRIEF DESCRIPTION OF THE DRAWINGS

Objects and features of the present invention will be further apparent from the following description of preferred embodiments and accompanying drawings.

FIG. 1 is an external perspective view showing an example of the configuration of a portable terminal according to an embodiment of the present invention;

FIG. 2 is a block diagram showing an example of the configuration of a content reproduction system according to the embodiment of the present invention;

FIG. 3 is a flowchart showing a specific example of the operation of the portable terminal according to the embodiment of the present invention;

FIG. 4A is a diagram showing an example of an image display portion on which content information is displayed;

FIG. 4B is a diagram showing an example of an image display portion on which content information is displayed;

FIG. 5 is a diagram showing an example of the image display portion on which EPG information is displayed; and

FIG. 6 is a diagram showing an example of the image display portion on which a RC image is displayed.

### DETAILED DESCRIPTION OF PREFERRED EMBODIMENTS

A portable terminal and a content reproduction system according to an embodiment of the present invention will be described with reference to accompanying drawings.

<Portable Terminal>

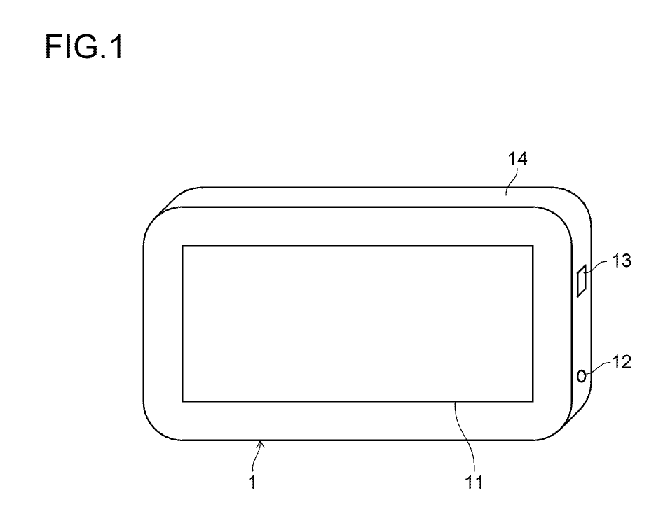

An example of the configuration of the portable terminal according to the embodiment of the present invention will first be described with reference to FIG. 1. FIG. 1 is an external perspective view showing the example of the configuration of the portable terminal according to the embodiment of the present invention. As shown in FIG. 1, the portable terminal 1 of the present example includes: an image display portion 11 that displays an image; a sound output portion 12 that outputs sound; and a communication portion 13 that communicates with an electronic device. The portable terminal 1 also includes an enclosure 14 in which the image display portion 11, the sound output portion 12 and the communication portion 13 are arranged.

The image display portion 11 is composed of: for example, a monitor that is formed with, for example, a liquid crystal display; and the like. The sound output portion 12 is composed of: for example, a jack into which the plug of earphones is inserted; and the like. In the portable terminal of the present example, the image display portion 11 and the sound output portion 12 reproduce content (such as an image, sound, a document and information).

The reproduction of content includes displaying of the file of an image (such as a still image or a moving image), the file of a document, the file of information and the like, as images. The reproduction of content also includes outputting of the file of sound (such as music or a conversation), a signal of sound included in the file of a moving image and the like, as sound (the reproduction of content can include not only the actual production of sound but also the output of a signal for producing sound through earphones, a speaker or the like; the same is true in the following description).

The communication portion 13 encodes and modulates a signal to be transmitted to an electronic device, and then transmits the resulting signal to the electronic device. The communication portion 13 also receives a signal transmitted from the electronic device, and demodulates and decodes it. The communication portion 13 communicates with the electronic device by a method that conforms to common standards such as DNNA. As long as the communication portion 13 can communicate with the electronic device, the communication portion 13 can acquire content anywhere (for example, in areas other than the vicinity of the electronic device).

The enclosure 14 is formed substantially in the shape of a rectangular parallelepiped (a flat plate). The enclosure 14 has: two main surfaces that have a large area and that are substantially parallel to each other; and side surfaces that are substantially perpendicular to the main surfaces and that have a small area. In one of the main surfaces of the enclosure 14, the image display portion 11 is arranged. On the other hand, in the side surface of the enclosure 14, the sound output portion 12 and the communication portion 13 are arranged.

In the portable terminal 1 of the present example, a user touches a desired position on the image display portion 11 (on an image displayed), and thereby inputs an instruction to the portable terminal 1. In other words, the image display portion 11 forms part of a so-called touch panel.

With the configuration described above, the portable terminal 1 can acquire content from the electronic device and reproduce it anywhere. Thus, it is possible to reduce the limitation of the location where the user can watch content. It is therefore possible to improve the degree of freedom in watching content.

Since the portable terminal 1 can communicate with the electronic device, and thus can acquire content from the electronic device, the portable terminal 1 itself does not need to be present under circumstances in which content can be produced (for example, under circumstances in which signals transmitted from a broadcast station can be received). As described above, the electronic device that communicates with the portable terminal 1 is generally present under circumstances in which content is satisfactorily produced (for example, under circumstances in which signals transmitted from a broadcast station can be satisfactorily received). Hence, the portable terminal 1 acquires content from the electronic device, and thus it is possible to acquire content effectively.

The configuration of the portable terminal 1 shown in FIG. 1 is simply one example; as long as the portable terminal 1 can acquire content from the electronic device and reproduce it, any configuration may be used. For example, in addition to (or instead of) the jack, the sound output portion 12 may be provided with a sound producing device such as a speaker. The enclosure 14 may have any shape; the image display portion 11, the sound output portion 12, the communication portion 13 and the enclosure 14 may be arranged on any surface.

The communication portion 13 may be configured such that it can transmit signals by a plurality of methods. For example, in addition to the communication by the method that conforms to common standards as described above, the communication portion 13 may be configured such that infrared signals can be transmitted. Specifically, for example, by the method that conforms to common standards, the communication portion 13 communicates with an electronic device with which communication is established whereas the communication portion 13 may transmit infrared signals to an electronic device with which communication cannot be established.

<Content Reproduction System>

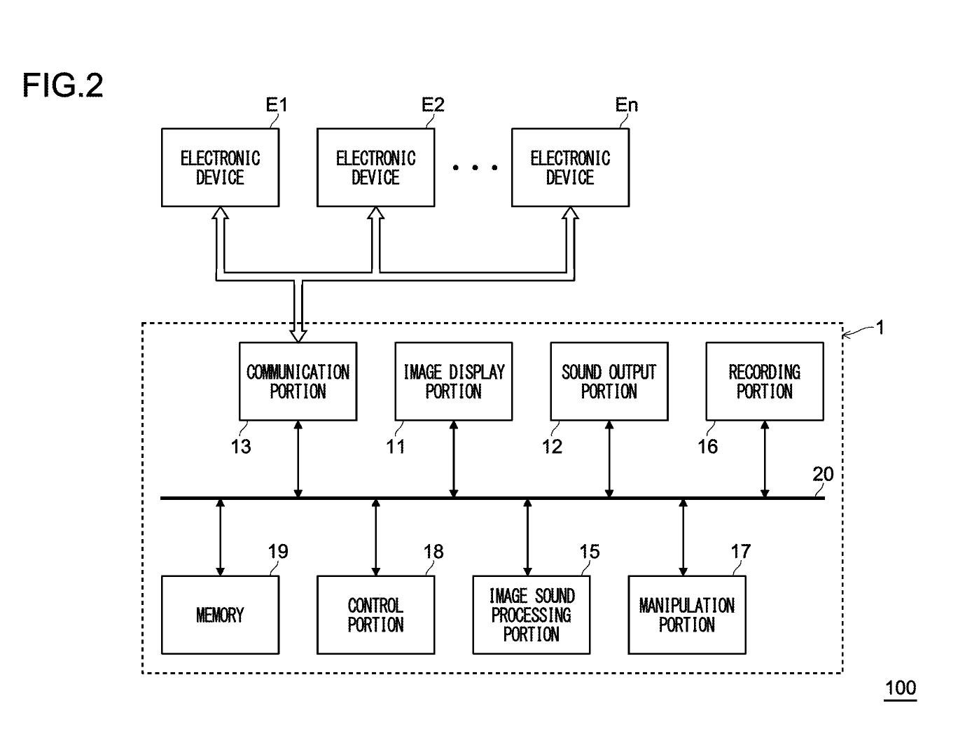

An example of the configuration of the content reproduction system according to the embodiment of the present invention will now be described with reference to FIG. 2. FIG. 2 is a block diagram showing the example of the configuration of the content reproduction system according to the embodiment of the present invention.

As shown in FIG. 2, the content reproduction system 100 of the present example includes: the portable terminal 1 described above; and at least one of electronic devices En (n is a natural number) that can communicate with the portable terminal 1. Although FIG. 2 shows as if at least three electronic devices En are present, this simply indicates that the portable terminal 1 can communicate with a plurality of electronic devices En. In other words, the portable terminal 1 may be configured to communicate with one or two electronic devices En.

As shown in FIG. 2, the portable terminal 1 includes: the image display portion 11; the sound output portion 12; the communication portion 13; the enclosure 14 (see FIG. 1); an image sound processing portion 15 that processes an image displayed on the image display portion 11 and sound output from the sound output portion 12; a recording portion 16 that records acquired content and the like; a manipulation portion 17 into which the user inputs an instruction; a control portion 18 that controls the operation of individual portions; a memory 19 that temporarily stores data; and a bus 20 through which the individual portions exchange data.

The image sound processing portion 15 processes, through the communication portion 13, content acquired from the electronic devices En, and generates a signal for an image to be displayed on the image display portion 11 and a signal for sound to be output from the sound output portion 12. For example, the image sound processing portion 15 decodes various types of files that are formats specified by DLNA, and thereby generates various signals.

The recording portion 16 records: the content acquired through the communication portion 13 from the electronic devices En; various types of information that indicate settings for the operation of the portable terminal 1; a program for performing processing by the control portion 18; and the like. The recording portion 16 is formed with a nonvolatile semiconductor memory or the like. The content recorded in the recording portion 16 may be processed by the image sound processing portion 15 and be reproduced by the image display portion 11 and the sound output portion 12.

The manipulation portion 17 is manipulated by the user, and thus an instruction from the user is input into the portable terminal 1. Specifically, for example, when the manipulation portion 17 is formed as part of the touch panel described previously, the manipulation portion 17 is formed with a sensor (such as a conductive film or an electrical detection element) that detects the position touched by the user on the image display portion 11.

The control portion 18 has, for example, a computation element such as a CPU (central processing unit), and controls the operation of the individual portions of the portable terminal 1. The memory 19 is formed with, for example, a volatile semiconductor memory, and temporarily stores data when the image sound processing portion 15 and the control portion 18 are operated. The individual portions of the portable terminal 1 exchange data through the bus 20.

The electronic devices En communicate with the communication portion 13 of the portable terminal 1 by a method that conforms to common standards such as DNNA. The electronic devices En may be configured such that they can communicate with other electronic devices; the communication may be performed by the method that conforms to common standards as described above. In addition to the communication performed by the method that conforms to common standards as described above, the electronic devices En may be configured that they can receive infrared signals transmitted from the portable terminal 1.

<Specific Operation Example>

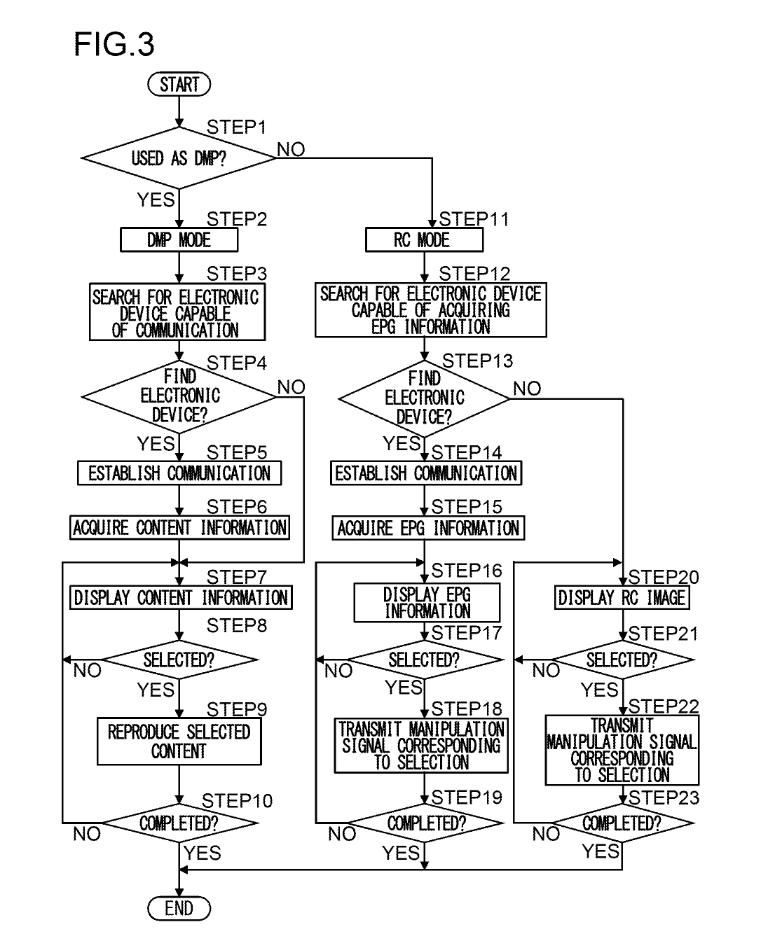

A specific example of the operation of the portable terminal 1 according to the embodiment of the present invention will now be described with reference to FIG. 3. FIG. 3 is a flowchart showing the specific example of the operation of the portable terminal according to the embodiment of the present invention. The portable terminal 1 of the present specific example can be operated as a remote controller (hereinafter also referred to as a RC) for the electronic devices En (for example, a television apparatus). The portable terminal 1 of the present specific example can communicate with a plurality of electronic devices En. Furthermore, the portable terminal 1 of the present specific example can be operated not only as the remote controller for the electronic devices En but also as a digital media player (hereinafter, DMP) that can reproduce various types of content such as files of moving images and sound.

As shown in FIG. 3, when the portable terminal 1 of the present specific example starts its operation, the user first selects whether the portable terminal 1 is used as the DMP or the remote controller (step 1). Here, images for selecting the DMP and the remote controller are displayed on, for example, the image display portion 11, and the user operates the manipulation portion 18 (for example, touches a region of the image display portion 11 where a desired image is displayed), and thereby selects the DMP or the remote controller.

If the user selects the use of the portable terminal 1 as the DMP (yes in step 1), the portable terminal 1 enters a DMP mode (step 2). Then, the portable terminal 1 searches for the electronic device En with which the portable terminal 1 can first communicate (step 3). For example, the portable terminal 1 searches for the electronic device En with which the portable terminal 1 can communicate, by checking whether the communication portion 13 transmits a predetermined signal and receives, as the response to the signal, a signal transmitted by the electronic device En.

If the portable terminal 1 finds the electronic device En with which the portable terminal 1 can communicate (yes in step 4), the communication with the electronic device En is established (step 5). The portable terminal 1 and the electronic device En are brought into a state in which communicate can be performed, such as by determining a band for performing the communication. Then, the portable terminal 1 acquires content information from the electronic device En with which the communication is established (step 6).

The content information refers to information indicating content that the portable terminal 1 can reproduce. In the above case, the content information refers to information indicating content that can be transmitted from the electronic device En to the portable terminal 1. For example, the content information is information indicating content that the electronic device En has at present. Information indicating content that the electronic device En can produce (for example, that can be acquired from a signal transmitted by a broadcast station) may be included in the content information. Information indicating content that is recorded in the recording portion 16 of the portable terminal 1 may be included in the content information. The content information itself is information that can be acquired from the electronic device En, and can be regarded as one piece of content.

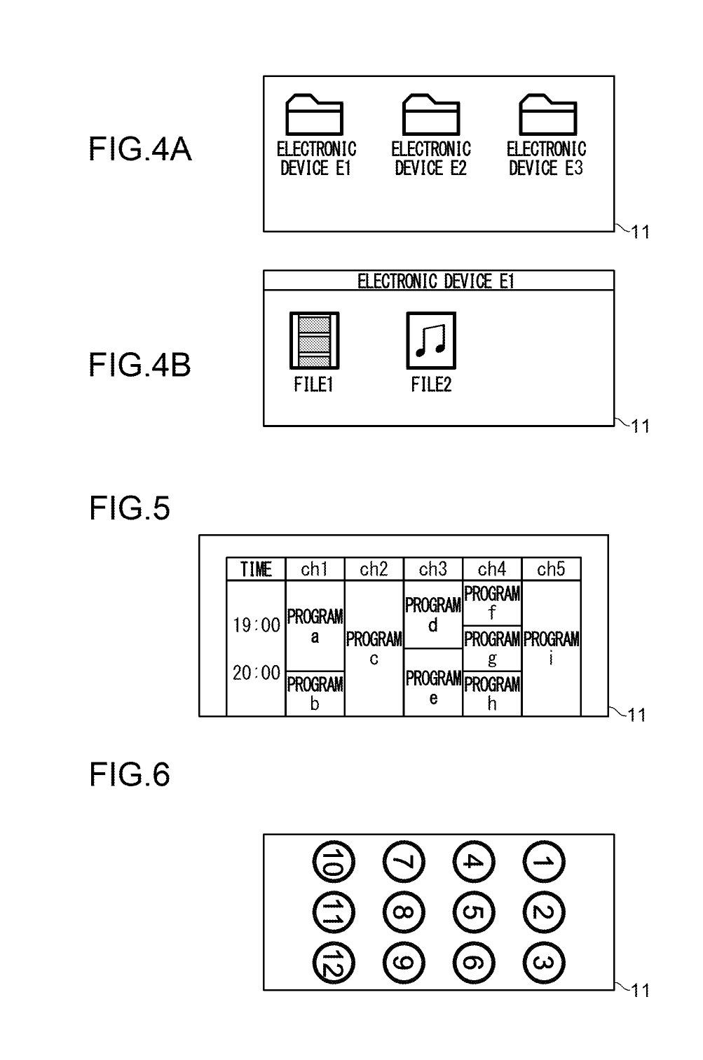

If the portable terminal 1 acquires the content information from the electronic device En or the portable terminal 1 cannot find the electronic device En with which the portable terminal 1 can communicate (no in step 4), the image display portion 11 displays the content information (step 7). Thus, the content that the portable terminal 1 can reproduce is displayed on the image display portion 11. An example of the image displayed on the image display portion 11 at this time will be described with reference to FIG. 4A and FIG. 4B. FIG. 4A and FIG. 4B is a diagram showing an example of the image display portion on which the content information is displayed.

In the example shown in FIG. 4A and FIG. 4B, it is possible to acquire content from the electronic devices E1 to E3, and the electronic device E1 has a moving image file 1 and a sound file 2. In this case, the control portion 18, the image sound processing portion 15 and the image display portion 11 may be operated such that the images shown in FIG. 4A and representing the electronic devices E1 to E3 which can perform communication and the images shown in FIG. 4B and representing content held by the electronic devices E1 to E3 which can perform communication are sequentially displayed according to the instruction from the user that is input through the manipulation portion 17. Specifically, for example, the user touches a region where the electronic device E1 of FIG. 4A is displayed, and thus the image of FIG. 4B may be displayed. The example shown in FIG. 4A and FIG. 4B is only one example; the content that can be reproduced and the electronic devices E1 to E3 that can perform communication may be represented by another method (for example, by a method using a tree structure).

The user checks the displayed content information and selects the content to be reproduced (step 8). For example, the user who has checked the content information displayed on the image display portion 11 touches a region where an image indicating the content to be reproduced is displayed, and thereby selects the content to be reproduced. Until the user selects the content to be reproduced (no in step 8), the image display portion 11 displays the content information as shown in FIG. 4A and FIG. 4B.

On the other hand, if the user selects the content (yes in step 8), the content is reproduced by the image display portion 11 and the sound output portion 12 (step 9). While the content is being reproduced, the communication portion 13 may acquire, from the electronic devices En, as necessary, the remaining part of the content being reproduced, or before the reproduction, the content may be acquired and either recorded in the recording portion 16 or stored in the memory 19.

Then, if the user provides an instruction to complete the use of the portable terminal 1 as the DMP (yes in step 10), the operation is completed. On the other hand, if an instruction to complete the operation is not provided (no in step 10), for example, the process returns to step 7 where the image display portion 11 displays the content information.

A case where the portable terminal 1 is used as the remote controller will now be described. If the user selects the use of the portable terminal 1 as the remote controller (no in step 1), the portable terminal 1 enters a RC mode (step 11). Then, the portable terminal 1 first searches for the electronic device En that can acquire EPG (electronic program guide) information (step 12). The EPG information refers to information indicating a plan (a so-called program list) for programs broadcast by a broadcast station. The EPG information and the programs broadcast by the broadcast station are information that can be acquired from the electronic devices En, and can be considered to be one piece of content.

For example, the EPG information is included in part of signals transmitted by the broadcast station, and can be obtained as a result of the signals being demodulated and decoded. Hence, the signals can be obtained from an electronic device (such as a television apparatus, a set top box or a recorder) incorporating a tuner. The portable terminal 1 searches for the electronic device En, for example, as in step 3 described above; specifically, the portable terminal 1 searches for the electronic device En from which the EPG information can be acquired, among the electronic devices En from which the response is received.

If the portable terminal 1 finds the electronic device En from which the EPG information can be acquired (yes in step 13), as in step 5 described above, the communication with the electronic device En is established (step 14). Then, the portable terminal 1 acquires the EPG information from the electronic device En with which the communication is established (step 15).

The portable terminal 1 displays the acquired EPG information on the image display portion 11 (step 16). Thus, programs that the electronic device En can process are displayed on the image display portion 11. An example of the image displayed on the image display portion 11 at this time will be described with reference to FIG. 5. FIG. 5 is a diagram showing an example of the image display portion on which the EPG information is displayed.

In the example shown in FIG. 5, the EPG information is represented by combining programs a to i that are broadcast on channels ch1 to ch5 and time periods in which the programs a to i are broadcast. The example shown in FIG. 5 is only one example; the EPG information may be represented by another method.

The user checks the displayed EPG information, and selects the program (or channel) to be processed (step 17). For example, the user who has checked the EPG information displayed on the image display portion 11 touches a region where an image indicating the program to be processed is displayed, and thereby selects the program to be processed. Until the user selects the program to be processed (no in step 17), the image display portion 11 displays the EPG information as shown in FIG. 5.

On the other hand, if the user selects the program (yes in step 17), the portable terminal 1 transmits a manipulation signal to the electronic device En so that the program is processed by the electronic device En (step 18). The manipulation signal is a signal with which an instruction to operate the electronic device En is provided.

Specifically, for example, the television apparatus that has received the manipulation signal reproduces the program selected by the user. For example, the recorder that has received the manipulation signal records the program in a recording medium (such as a magnetic disc, an optical disc or a semiconductor memory; the same is true in the following description). The portable terminal 1 may transmit the manipulation signal to one of the electronic devices En or may transmit the manipulation signal to a plurality of electronic devices En.

Then, if the user provides an instruction to complete the use of the portable terminal 1 as the remote controller (yes in step 19), the operation is completed. On the other hand, if an instruction to complete the operation is not provided (no in step 19), for example, the process returns to step 16 where the image display portion 11 displays the EPG information.

If the portable terminal 1 cannot find the electronic device En from which the EPG information can be acquired (no in step 13), the portable terminal 1 displays a RC image (step 20). For example, the RC image refers to an image for displaying a channel on which the television apparatus can perform reception processing and reproduction. An example of the image displayed on the image display portion 11 at this time will be described with reference to FIG. 6. FIG. 6 is a diagram showing an example of the image display portion on which the RC image is displayed.

In the example shown in FIG. 6, selectable channels 1 to 12 are represented by an image that represents buttons. The example shown in FIG. 6 is only one example; the RC image may be represented by another method.

The user checks the displayed RC image, and selects the channel to be processed (step 21). For example, the user who has checked the RC image displayed on the image display portion 11 touches a region where an image indicating the channel to be processed is displayed, and thereby selects the channel to be processed. Until the user selects the channel to be processed (no in step 21), the image display portion 11 displays the RC image as shown in FIG. 6.

On the other hand, if the user selects the channel to be processed (yes in step 21), as in step 18 described above, the portable terminal 1 transmits the manipulation signal to the electronic device En (step 22).

Then, if the user provides an instruction to complete the use of the portable terminal 1 as the remote controller (yes in step 23), the operation is completed. On the other hand, if an instruction to complete the operation is not provided (no in step 23), for example, the process returns to step 20 where the image display portion 11 displays the RC image.

With this configuration, it is possible to reproduce content, using the portable terminal 1 (remote controller) for manipulating the electronic devices En. Hence, even when the electronic devices En are far away, content can be reproduced with the portable terminal 1 (remote controller).

The portable terminal 1 acquires and reproduces, from the electronic device En, information (content) indicating choices of content, such as the content information or the EPG information, that at least one of the portable terminal 1 and the electronic device En can process (for example, reproduce or record). Hence, it is possible to present selectable content to the user. It is therefore possible for the user to easily select the content to be processed.

Moreover, the portable terminal 1 can present the EPG information to the user. Hence, the user can check programs to be broadcast without approaching the electronic device En (for example, a television apparatus). The user also can check programs to be broadcast by focusing on the portable terminal 1 at hand. Furthermore, the user can easily check the program to be processed (for example, to be reproduced or recorded), and can provide an instruction to process the program.

Even when the EPG information cannot be acquired, the portable terminal 1 can display the RC image. Hence, the user can select the channel to be processed (for example, to be reproduced or recorded) with the electronic device En (for example, a television apparatus).

Although a description is given of the case where, in step 9, the portable terminal 1 reproduces the content, the electronic device En may reproduce the content. In this case, the portable terminal 1 may output, to the electronic device En, the same manipulation signal as in step 18. Although a description is given of the case where, in step 18, the electronic device En processes the program, the portable terminal 1 may acquire the program from the electronic device En and process (for example, reproduce or record) the program.

<Variations and the Like>

The portable terminal of the embodiment of the present invention can be applied not only to the remote controller described above but also to various electronic devices, such as a PDA (personal digital assistant) and a mobile telephone, that can be easily carried. Moreover, the electronic device that is incorporated in the content reproduction system of the embodiment of the present invention and that can communicate with the portable terminal can be applied not only to the television apparatus and the recorder described above but also to various electronic devices such as a set top box that converts an acquired signal into a signal that can be viewed on a television apparatus or the like, a player that reads and reproduces content recorded in a recording medium, an audio device that mainly records a signal of sound in a recording medium and that reads the signal from the recording medium and that reproduces it and a personal computer that can perform various types of processing on content.

Part or all of the operation of the portable terminal 1 according to the embodiment of the present invention may be performed by a control device such as a microprocessor. Furthermore, all or part of functions realized by such a control device is written as a program, and the program is executed on a program execution device (for example, a computer), with the result that all or part of the functions may be realized.

In addition to the foregoing, the portable terminal 1 shown in FIG. 2 can be formed with hardware or a combination of hardware and software. When part of a drive light source setting portion is formed with software, a block of a portion formed with the software indicates a functional block of such a portion.

As has been described above, the portable terminal 1 can be considered to be a remote controller for remotely controlling the electronic devices En. This remote controller includes: a function portion (communication portion) that communicates with the electronic device En to acquire content from the electronic device En; a function portion (reproduction portion) that reproduces the content acquired through the communication portion; and a function portion (manipulation portion) which is manipulated by the user and into which an instruction from the user is thereby input. The communication portion transmits the manipulation signal that is a signal corresponding to the instruction from the user which is input through the manipulation portion and that instructs the electronic device En to operate. This manipulation signal is a signal which allows, for example, a television apparatus that is the electronic device En to reproduce a program selected by the user.

As described previously, one specific example of the electronic device En is a television apparatus. This television apparatus can communicate produced content with the television apparatus, and transmits it to the portable terminal 1 incorporating a reproduction portion that reproduces the content. Moreover, this television apparatus receives, from the portable terminal 1, the manipulation signal indicating an instruction to operate the television apparatus.

Although the embodiment of the present invention has been described above, the scope of the present invention is not limited to this embodiment, and many modifications are possible without departing from the spirit of the present invention. In the portable terminal and the content reproduction system according to the present invention, the portable terminal can acquire content from an electronic device and reproduce it anywhere. Thus, it is possible to reduce the limitation of the location where the user can watch content. It is therefore possible to improve the degree of freedom in watching content.

What is claimed is:

1. A portable terminal comprising:
a communication portion that communicates with an electronic device to acquire content from the electronic device; and
a reproduction portion that reproduces the content acquired through the communication portion.

2. The portable terminal of claim 1, further comprising:
a manipulation portion which is manipulated by a user such that an instruction from the user is input into the manipulation portion,
wherein the communication portion transmits a manipulation signal that is a signal corresponding to the instruction from the user input through the manipulation portion and that instructs the electronic device to operate.

3. The portable terminal of claim 1,
wherein the communication portion performs communication conforming to DLNA with the electronic device.

4. A content reproduction system comprising:
at least one electronic device; and
the portable terminal of claim 1 that can communicate with the electronic device,
wherein content produced by the electronic device is acquired by the portable terminal through the communication portion and is reproduced by the reproduction portion.

5. The content reproduction system of claim 4,
wherein the electronic device generates program plan information indicating a plan for programs to be broadcast by a broadcast station,
the portable terminal acquires the program plan information from the electronic device through the communication portion, and
the program plan information is reproduced by the reproduction portion.

6. The content reproduction system of claim 5,
wherein the portable terminal includes a manipulation portion which is manipulated by a user such that an instruction from the user is input into the manipulation portion, and
when at least one program indicted by the program plan information reproduced by the reproduction portion is specified by the user through the manipulation portion,
the portable terminal transmits, through the communication portion, to the electronic device, a manipulation signal that indicates an instruction to process the program specified by the user.

7. The content reproduction system of claim 6,
wherein the communication portion performs communication conforming to DLNA with the electronic device and transmits, to the electronic device, a manipulation signal that is a signal corresponding to the instruction from the user input through the manipulation portion and that instructs the electronic device to operate.

8. The content reproduction system of claim 7,
wherein the electronic device is a television apparatus, and
the manipulation signal is a signal that instructs the television apparatus to reproduce a program selected by the user.

9. A remote controller comprising:
a communication portion that communicates with an electronic device to acquire content from the electronic device;
a reproduction portion that reproduces the content acquired through the communication portion; and
a manipulation portion which is manipulated by a user such that an instruction from the user is input into the manipulation portion,
wherein the communication portion transmits a manipulation signal that is a signal corresponding to the instruction from the user input through the manipulation portion and that instructs the electronic device to operate.

10. The remote controller of claim 9,
wherein the manipulation signal is a signal that instructs a television apparatus that is the electronic device to reproduce a program selected by the user.

11. The remote controller of claim 9,
wherein program plan information indicating a plan for programs to be broadcast by a broadcast station is acquired from the electronic device through the communication portion, and the program plan information is reproduced by the reproduction portion.

12. The remote controller of claim 11,
wherein, when at least one program indicted by the program plan information reproduced by the reproduction portion is specified by the user through the manipulation portion,
the manipulation signal that indicates an instruction to process the program specified by the user is transmitted through the communication portion to the electronic device.

13. A television apparatus,
wherein generated content is transmitted to a portable terminal that can communicate with the television apparatus and that includes a reproduction portion which reproduces the content.

14. The television apparatus of claim 13,
wherein a manipulation signal that instructs the television apparatus to operate is received from the portable terminal.

15. The television apparatus of claim 14,
wherein the manipulation signal is a signal that instructs the television apparatus to reproduce a program selected by a user.

16. The television apparatus of claim 13,
wherein program plan information indicating a plan for programs to be broadcast by a broadcast station is generated, and
the program plan information is transmitted to the portable terminal.
